(19) United States
(12) Patent Application Publication
(10) Pub. No.: US 2023/0419902 A1
(43) Pub. Date: Dec. 28, 2023

(54) PIXEL CIRCUIT, DRIVING METHOD THEREOF AND ELECTROLUMINESCENT DISPLAY

(71) Applicant: ULTRADISPLAY INC., Zhubei City (TW)

(72) Inventor: Shih-Song CHENG, Zhubei City (TW)

(73) Assignee: ULTRADISPLAY INC., Zhubei City (TW)

(21) Appl. No.: 18/215,737

(22) Filed: Jun. 28, 2023

(30) Foreign Application Priority Data
Jun. 28, 2022 (TW) 111124030

(51) Int. Cl. G09G 3/3233; G09G 3/3291

(52) U.S. Cl. CPC G09G 3/3233; G09G 3/3291; G09G 2310/027

(57) ABSTRACT

Embodiments of the present application provide a pixel circuit, a driving method thereof, and a display device. The pixel circuit includes a grayscale converter and a current generator, wherein the grayscale converter is configured to receive a first data voltage and a second data voltage and correspondingly generate a grayscale voltage. Meanwhile, the grayscale voltage is changed by a ramp voltage to correspondingly control the duration for passing through the driving current, so that the electroluminescent element may emit light with a grayscale corresponding to a main grayscale or a sub-grayscale. In this way, high bit depth can be achieved, real grayscale of the pixel can be presented, the problem of grayscale confusion caused by a small data range can be improved, and the picture quality of the display can be increased.

### CROSS-REFERENCE TO RELATED DISCLOSURES

This disclosure claims priority to Taiwan Patent Disclosure Ser. No. 11/124,030, filed on Jun. 28, 2022, entitled “Pixel circuit, driving method thereof and electroluminescent display”, which is hereby incorporated by reference in its entirety.

### TECHNICAL FIELD

The present disclosure relates to a field of pixel circuits, in particular to a pixel circuit for an electroluminescent display.

### BACKGROUND

A electroluminescence display uses light Emitting Diode (LED) or Organic Light Emitting Diode (OLED) as a light-emitting device, and is widely used in consumer and industrial fields nowadays. The improving of display quality is an important and continuous target in developing display technique. No matter the driving substrate of a display uses the Thin Film Transistor (TFT) process used in a traditional display or the CMOS (Complementary Metal-Oxide-Semiconductor) process used in a micro display, a very strict requirement is applied on the photoelectric conversion accuracy, and a precise definition on grayscale determines the display quality.

In such displays, the data precision of grayscale is usually set by using a driving method in an analog way. Such data precision is a ratio of bit depth (or grayscale depth) to data range, and thus it is necessary for the pixel circuit to be operated in a larger data range, if the bit depth is to be increased while the data precision is kept the same. However, such method is limited by the performance of the device made in the process, and when the bit depth that the hardware architecture can achieve is fixed, the driver cannot perform switch for more grayscales in a fixed data range, which often renders grayscale mixed and the quality it can present is degraded.

### BRIEF SUMMARY

Aspects of the present disclosure provide a pixel circuit, a driving method thereof and an electroluminescent display, which may conduct switch among various grayscale in a small data range and the display quality is improved.

An embodiment of the present disclosure provides a pixel circuit, including a current generator configured to pass a driving current to an electroluminescent element; and a grayscale converter configured to receive a first data voltage, a second data voltage, a reference voltage, and a ramp voltage, and change the second data voltage and the first data voltage according to the reference voltage to generate a grayscale voltage correspondingly; and change the grayscale voltage according to the ramp voltage to control a duration of the driving current passes through the current generator, and drive the electroluminescent element to emit light with a grayscale corresponding to the duration. The grayscale includes a main grayscale corresponding to the first data voltage and a sub-grayscale corresponding to the second data voltage, and the sub-grayscale is one of a plurality of sub-grayscales between the main grayscale and a previous grayscale of the main grayscale and between the main grayscale and a next grayscale of the main grayscale.

In one embodiment of the present application, the grayscale converter includes: a converting circuit configured to receive the first data voltage and the second data voltage in response to a first control signal, receive the reference voltage in response to a third control signal, and receive the ramp voltage in response to the second control signal, the grayscale voltage increases or decreases progressively within the duration by being pulled by the ramp voltage; and a latch circuit coupled to the current generator, and configured to receive a first voltage and establish the first voltage at a second node to turn on the current generator, and configured to establish the first voltage at a first node to turn off the current generator within the duration.

In one embodiment of the present application, the converting circuit includes a first capacitor and a second capacitor connected in series. Wherein, the second capacitor is coupled between a third node and a fourth node. The first data voltage is established at the third node, the second data voltage is established at the fourth node. The second capacitor changes the second data voltage and the first data voltage according to the reference voltage to generate the gray scale voltage at the third node. The first capacitor is coupled to the third node and a ramp voltage end and configured to change the gray scale voltage according to the ramp voltage.

In one embodiment of the present application, the converting circuit further includes a second transistor respectively coupled to a data line and the third node, and configured to transmit the first data voltage to the third node in response to the first control signal; a fifth transistor respectively coupled to the data line and the fourth node, and configured to transmit the second data voltage to the fourth node in response to the first control signal; a sixth transistor respectively coupled to the first capacitor and the ramp voltage end, and configured to transmit the ramp voltage to the first capacitor in response to the second control signal; and a seventh transistor respectively coupled to the fourth node and a reference voltage end, and configured to transmit the reference voltage to the fourth node in response to the third control signal.

In one embodiment of the present application, the data line includes a first data line and a second data line, the second transistor is coupled between the first data line and the third node, and the fifth transistor is coupled between the second data line and the fourth node.

In one embodiment of the present application, a gate of the second transistor is coupled to a first branch signal line and configured to transmit the first data voltage to the third node in response to a first branch control signal of the first control signal, a gate of the fifth transistor is coupled to a second branch signal line, and configured to transmit the second data voltage to the fourth node in response to a second branch control signal of the first control signal.

In one embodiment of the present application, the latch circuit includes: a first transistor respectively coupled to a first voltage end and the second node, and configured to transmit the first voltage to the second node in response to the first control signal; a third transistor respectively coupled to the first node, the third node, and the first voltage end, and configured to transmit the first voltage to the first node in response to the grayscale voltage; a set of back-to-back inverters coupled between the first node and the second node, and configured to maintain the first voltage at the first node and simultaneously establish a second voltage opposite to the first voltage at the second node, or maintain the second voltage at the second node and simultaneously establish the first voltages at the first node.

In one embodiment of the present application, the back-to-back inverters includes a first inverter and a second inverter, a first output of the first inverter being coupled to the second node and to a second input of the second inverter, and a second output of the second inverter being coupled to the first node and to a first input of the first inverter.

In one embodiment of the present application, the latch circuit includes: a first transistor respectively coupled to a first voltage end and the second node, and configured to transmit the first voltage to the second node in response to a fourth control signal; a third transistor respectively coupled to the first voltage end, the first node, and the third node, and configured to transmit the first voltage to the first node in response to the grayscale voltage; a ninth transistor respectively coupled to the first voltage end and the third node, and configured to transmit the first voltage to the third node in response to the fourth control signal to turn off the third transistor; and a set of back-to-back inverters, coupled between the first node and the second node, and configured to maintain the first voltage at the first node and simultaneously establish a second voltage opposite to the first voltage at the second node, or maintain the second voltage at the second node and simultaneously establish the first voltages at the first node.

In one embodiment of the present application, the current generator includes: a driving circuit coupled to the first node, and configured to receive the first voltage and transmit the driving current to a switching circuit, and be turned on or off according to a voltage level of the first node; and a switching circuit coupled between the driving circuit and the electroluminescent element, and configured to receive and transmit the driving current to the electroluminescent element in response to a light signal.

In one embodiment of the present application, the driving circuit includes a fourth transistor. A gate of the fourth transistor being coupled to the first node and configured to be turned off in response to the first voltage. The switching circuit includes an eighth transistor. A gate of the eighth transistor is coupled to a light signal end and is configured to pass the driving current in response to the light signal.

In one embodiment of the present application, the pixel circuit further includes a compensation circuit. The driving circuit is coupled to the fifth node, the switching circuit is coupled to the seventh node. The compensation circuit is coupled between a fifth node and a seventh node and configured to establish a compensation voltage at a sixth node in response to a fifth control signal, and transmit a compensation current to that switching circuit according to the compensation voltage.

In one embodiment of the present application, the compensation circuit includes: a third capacitor coupled between the fifth node and the sixth node, and configured to maintain a voltage difference between the fifth node and the sixth node; an eleventh transistor coupled between the sixth node and the seventh node, and configured to transmit a compensation voltage to the sixth node in response to a fifth control signal; a twelfth transistor respectively coupled to the seventh node and a compensation current end, and configured to pass the compensation current in response to the fifth control signal; and a tenth transistor coupled to the fifth node, the sixth node, and the seventh node respectively, and configured to transmit the compensation current to the switching circuit in response to the compensation voltage.

An embodiment of the present application also provides an electroluminescent display, including an array of pixel cells, wherein each pixel cell comprises any of the pixel circuits described above and an electroluminescent element coupled to the pixel circuit.

An embodiment of the present application provides a driving method for driving a pixel circuit, including: providing a first data voltage and a second data voltage to a grayscale converter to determine a main grayscale and a sub-grayscale, wherein the sub-grayscale is one of a plurality of sub-grayscales between the main grayscale and a previous grayscale of the main grayscale and between the main grayscale and a next grayscale of the main grayscale; turning on a current generator and applying a light signal to the current generator to pass a driving current to an electroluminescent element; providing a reference voltage to the grayscale converter to change the second data voltage and the first data voltage and correspondingly generate a grayscale voltage, and providing a ramp voltage to the grayscale converter to change the grayscale voltage so as to control a duration for passing the driving current, and drive the electroluminescent element to emit light with the main grayscale or the sub-grayscale corresponding to the duration.

In one embodiment of the present application, the driving method further includes establishing a second voltage at the grayscale converter to turn on the current generator, and changing the second voltage into a first voltage when the duration is over, so as to turn off the current generator and cut off the driving current.

In one embodiment of the present application, the driving method further includes: applying a first control signal to a converting circuit of the grayscale converter to establish the first data voltage at a third node and the second data voltage at a fourth node; receiving the first voltage by a latch circuit of the grayscale converter, and establishing the first voltage at a second node, and correspondingly generating the second voltage at a first node; turning on a driving circuit of the current generator in response to the second voltage and transmitting the driving current to the switching circuit; passing the driving current by the switching circuit in response to the light signal, and driving the electroluminescent element to emit light; applying a third control signal to the converting circuit to receive the reference voltage to the fourth node to change the second data voltage, and correspondingly change the first data voltage by a second capacitor to generate the grayscale voltage at the third node; applying a second control signal to the converting circuit to receive the ramp voltage and pull the grayscale voltage to be increased or decreased within a duration corresponding to the main grayscale or the sub-grayscale by a first capacitor, and transmitting, by the latch circuit, the first voltage to the first node in response to a changed grayscale voltage when the duration is over, to turn off the driving circuit.

In one embodiment of the present application, the driving method further includes: turning on a first transistor of the latch circuit to receive and transmit the first voltage to the second node; converting the first voltage to the second voltage by a set of back-to-back inverters between the second node and the first node, and transmitting the second voltage to the first node; and turning off the first transistor and turning on the third transistor of the latch circuit when the duration is over, to receive and transmit the first voltage to the first node, and simultaneously convert the first voltage into the second voltage by the back-to-back inverters and transmit the second voltage to the second node.

In one embodiment of the present application, the driving method further includes: applying a fourth control signal to the first transistor to turn on the first transistor, and applying the fourth control signal to a ninth transistor of the latch circuit to pass the first voltage to the third node such that the third transistor is turned off in response to the first voltage.

In one embodiment of the present application, the step of applying a light signal to the current generator to pass a driving current to an electroluminescent element further includes: applying a fifth control signal to a compensation circuit to establish a compensation voltage and turn on the compensation circuit; converting the driving current into a compensation current according to the compensation voltage; and applying the light signal to the current generator to pass the compensation current to the electroluminescent element.

The pixel circuit provided in the embodiment of the present application is configured to receive a first data voltage and a second data voltage, and the first data voltage is used as a main grayscale voltage, and the second data voltage is used as a adjusting voltage of the main grayscale voltage, and simultaneously control a duration for passing through the driving current upon action of a ramp voltage, so that electroluminescent element may emit light with the main grayscale or sub-grayscale. More particularly, with the above adjusting method, each main grayscale may be subdivided into multiple sub-grayscales, so that the grayscale that can be shown by the electroluminescent element may be set more subtly to achieve a presentation close to the real grayscale. In this way, the grayscale confusion caused by too small data interval can be improved, and the picture quality of the display can be specifically improved.

### BRIEF DESCRIPTION OF THE DRAWINGS

The drawings described herein are intended to provide a further understanding of the present disclosure, and are incorporated in and constitute a part of this specification, schematic embodiments of the disclosure and together with the description serve to explain the principles of the present disclosure, and do not constitute an improper limitation of the present disclosure. It should be noted that, in accordance with standard practice in the art, the features in the diagram are not drawn to scale. In fact, the dimensions of certain features may be deliberately enlarged or reduced for clear description. In the drawings:

FIG. 1 is a block diagram of the pixel circuit according to an embodiment of the present disclosure.

FIG. 2 is a circuit diagram of a pixel circuit according to an embodiment of the present disclosure.

FIG. 3 is a schematic diagram of the main grayscale and the sub-grayscale according to an embodiment of the present disclosure.

FIG. 4a is an operation timing diagram of the pixel circuit according to the embodiment shown in FIG. 2 at time t1.

FIG. 4b is a schematic diagram of the operation of the pixel circuit according to the embodiment shown in FIG. 2 at time t1 shown in FIG. 4a.

FIG. 5a is an operation timing diagram of the pixel circuit according to the embodiment shown in FIG. 2 at time t2.

FIG. 5b is a schematic diagram of the operation of the pixel circuit according to the embodiment shown in FIG. 2 at time t2 shown in FIG. 5a.

FIG. 6a is an operation timing diagram of the pixel circuit according to the embodiment shown in FIG. 2 at time t3.

FIG. 6b is a schematic diagram of the operation of the pixel circuit according to the embodiment shown in FIG. 2 at time t3 shown in FIG. 6a.

FIG. 7 is a flowchart of a driving method of driving the pixel circuit according to the embodiment of FIG. 2.

FIG. 8 is a circuit diagram of a pixel circuit according to another embodiment of the present disclosure.

FIG. 9 is a circuit diagram of a pixel circuit according to some embodiments of the present disclosure.

FIG. 10a is an operation timing diagram of the pixel circuit according to the embodiment shown in FIG. 9 at time t1.

FIG. 10b is a schematic diagram of the operation of the pixel circuit according to the embodiment shown in FIG. 9 at time t1 shown in FIG. 10a.

FIG. 11a is an operation timing diagram of the pixel circuit according to the embodiment shown in FIG. 9 at time t2.

FIG. 11b is a schematic diagram of the operation of the pixel circuit according to the embodiment shown in FIG. 9 at time t2 shown in FIG. 11a.

FIG. 12a is an operation timing diagram of the pixel circuit according to the embodiment shown in FIG. 9 at time t3.

FIG. 12b is a schematic diagram of the operation of the pixel circuit according to the embodiment shown in FIG. 9 at time t3 shown in FIG. 12a.

### DETAILED DESCRIPTION

Hereinafter, the present disclosure will be described in detail with reference to the accompanying drawings along with illustrated embodiments, so as to better clarify the object, technical solution and advantageous of the present disclosure. It can be conceivable that such descriptions are merely exemplary and are not intended to limit the present disclosure.

Transistors used in all embodiments of the present disclosure may be thin-film transistors or field-effect transistors (FET) or other devices with the same characteristics, e.g., metal-oxide-semiconductor (MOS) transistors. Meanwhile, in order to distinguish the two electrodes of the transistor other than the gate electrode (Gate), one of the two electrodes may be referred as the first electrode, and the other electrode may be referred as the second electrode. One skilled in the art would understand that the drain and source of the transistor are interchangeable, depending on the voltage level applied thereto. Therefore, in practical operations, the first electrode may be the drain electrode, and the second electrode may be the source electrode; alternatively, the first electrode may be the source electrode, and the second electrode may be the drain electrode.

Further, it should be understood that if one component is described as being “connected to” or “coupled to” another component, these two components may be directly connected or coupled to each other, or there may be other intervening component therebetween. Further, when a device is of the type of positive edge trigger (active high), a signal is asserted to a high logical level to start the device. Conversely, the signal is deasserted to a low logical level to deactivate the device. However, when a device is of the type of negative edge trigger (active low), a signal is deasserted to a low logical level to start the device, and it is asserted to a high logical level to deactivate the device.

In addition, the expression of first, second, etc. added before some constituent elements in the embodiments of the present application are only for the convenience of description and understanding of the contents of the embodiments of the present application, and are not used to indicate the number or order of the constituent elements.

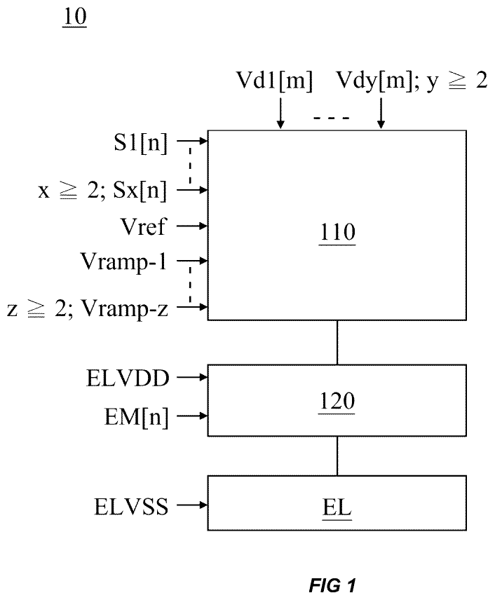

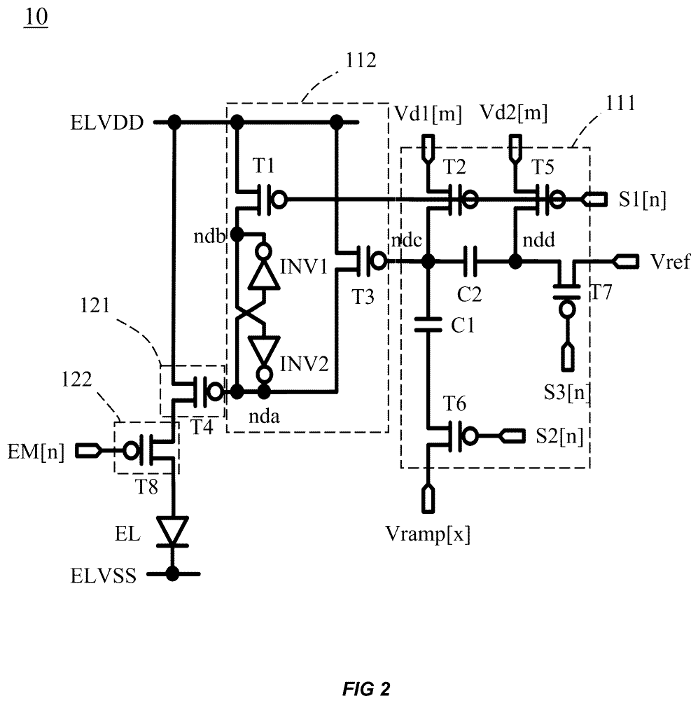

Reference now may be made to FIG. 1 and FIG. 2, embodiments of the present disclosure provide a pixel circuit 10, which may be configured to be used in an electroluminescent display, to drive an electroluminescent element EL to emit light, and to adjust the grayscale conversion of the electroluminescent element EL. The electroluminescent display includes a display panel, a gate driver, a source driver, and a power driver. The display panel is provided with a plurality of pixels arranged in a matrix, and the pixels are arranged in a manner of N rows*M columns, and N and M are natural numbers respectively. The gate driver supplies a control signal and a light signal to the pixels of the n t h row via the signal terminals S1 [n] to Sx [n] (1≤n≤N, x≥2) of N signal lines. The source driver provides a data voltage to a selected pixel in the mₜₕ row of pixels through data terminals Vd1 [m], Vdy [m] (1≤m≤M, y≥2) of M data lines. The power driver provides a first voltage ELVDD and a second voltage ELVSS to a display region. In addition, a DC bias source provides a reference voltage Vref and a ramp voltage of the ramp voltage terminal Vramp [x] (1≤x≤z, z≥2) to the display area. In one embodiment, the first voltage ELVDD is about 5 volts (5V), the second voltage ELVSS is about −5V, and the reference voltage Vref is about 2.5V.

The pixel circuit 10 includes a grayscale converter 110 and a current generator 120. The grayscale converter 110 includes a converting circuit 111 and a latch circuit 112. The converting circuit 111 is coupled to the signal terminals S1[n] to S3 [n], the data terminals Vd1 [m] to Vd2[m], a reference voltage terminal and the ramp voltage terminal Vramp[x], and is configured to receive a first data voltage and a second data voltage in response to a first control signal, receive a ramp voltage in response to a second control signal, and receive the reference voltage Vref in response to a third control signal. Meanwhile, the converting circuit 111 is configured to change the first data voltage and the second data voltage within one frame time according to the reference voltage Vref to generate a grayscale voltage, and changes the grayscale voltage within the same frame time according to the ramp voltage, for example, pulls the grayscale voltage down to almost zero.

Reference now may be made to FIG. 2. In an embodiment of the present application, the converting circuit 111 includes a first capacitor C1 and a second capacitor C2 connected in series. One end of the first capacitor C1 is coupled to a third node ndc, and the other end of the first capacitor C1 is coupled to the ramp voltage end Vramp[x] and configured to receive the ramp voltage and adjust the voltage level of the third node ndc according to the ramp voltage. The second capacitor C2 is coupled between the third node ndc and a fourth node ndd and configured to store the first data voltage at the third node ndc and store the second data voltage at the fourth node ndd. The first data voltage is used as a main grayscale voltage corresponding to a main grayscale when the electroluminescent element EL emits light. The second data voltage is used as an adjusting voltage of the main grayscale voltage for adjusting the main grayscale voltage into a sub-grayscale voltage on the basis of the main grayscale voltage. This grayscale voltage corresponds to a sub-grayscale when the electroluminescent element EL emits light. In the embodiment of the present application, the sub-grayscale is one of a plurality of sub-grayscales between the main grayscale and its previous and next grayscales.

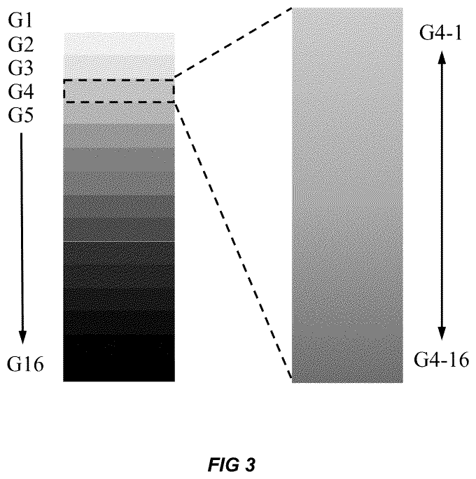

For example, in a grayscale mode with a bit depth of 4 bits, an image has 2⁴, i.e., 16, possible grayscale values (as shown in FIG. 3). In one frame time, one of the 16 grayscales G1-G16 may be used as the main grayscale of the electroluminescent element EL, for example, the electroluminescent element EL emits light with a grayscale of G4 to show a first grayscale image. Alternatively, with adjustment to the second data voltage in the same frame time, a sub-grayscale of the grayscale G4 itself may be selected as the second grayscale to drive the electroluminescent element EL to emit light. That is, with the hardware architecture unchanged, there are 16 possible sub-grayscales G4-1 to G4-16 between a previous grayscale G3 and a next grayscale G5 with respect to the grayscale G4. And one of the 16 sub-grayscales G4-1 to G4-16 may be used as a second grayscale to drive the electroluminescent element EL to emit light so as to present a second grayscale image which is closer to a real image.

Similarly, in some embodiments of the present disclosure, when the bit depth is 8 bits, an image may have 2⁸, i.e., 256, possible main grayscales, and each main grayscale has 2⁸, i.e., 256, possible sub-grayscales between a previous grayscale and a next grayscale with respect to this main grayscale, so that the electroluminescent device EL may emit light with the main grayscale or sub-grayscales.

Therefore, when the converting circuit 111 transmits the received reference voltage Vref to the fourth node ndd, the second data voltage is changed, and the first data voltage is changed correspondingly by the second capacitor C2, so that a grayscale voltage corresponding to the main grayscale or the sub-grayscale is generated at the third node ndc, to drive the electroluminescent element EL to emit light with the main grayscale or the sub-grayscale. In such adjusting mode that the main grayscale is used with the sub-grayscale, with the hardware architecture of the electroluminescence display unchanged, the first data voltage may be adjusted by the second data voltage so as to perform fine adjustment operation to increase or decrease corresponding main grayscale value, and thus a finer picture can be presented, and the problem of grayscale confusion can be solved.

Reference now may be made to FIG. 1 and FIG. 2. The latch circuit 112 of the grayscale converter 110 is coupled to the power driver, the converting circuit 111, and the current generator 120, respectively, and configured to receive the first voltage ELVDD in response to a control signal and correspondingly generate the second voltage ELVSS at a first node nda to turn on the current generator 120; and configured to receive the first voltage ELVDD in response to the changed grayscale voltage and change the second voltage ELVSS of the first node nda to the first voltage ELVDD to turn off the current generator 120.

The current generator 120 includes a driving circuit 121 and a switching circuit 122. The driving circuit 121 is respectively coupled to the power driver, the first node nda of the latch circuit 112 and the switching circuit 122, and configured to receive the first voltage ELVDD to generate a driving current, and is turned on in response to the second voltage ELVSS of the first node nda to pass the driving current to the switching circuit 122, Or is turned off in response to the first voltage ELVDD of the first node nda to cut off the pass of the driving current. The switching circuit 122 is respectively coupled to the driving circuit 121 and the electroluminescent element EL, and is turned on in response to a light signal from a light signal end EM[n] to transmit the driving current to the electroluminescent element EL.

Specifically, in some embodiments of the present application, the converting circuit 111 of the grayscale converter 110 further includes a second transistor T2, a fifth transistor T5, a sixth transistor T6, and a seventh transistor T7.

The second transistor T2 has a gate coupled to a first signal terminal S1 [n] and configured to respond to the first control signal, a first terminal coupled to the third node ndc at one terminal of the second capacitor C2, and a second terminal coupled to the first data end Vd1[m] and configured to receive the first data voltage. The second transistor T2 has a gate coupled to the first signal line for receiving the first control signal S1, a first terminal coupled to a second node ndb located between the first capacitor C1 and the second capacitor C2, and a second terminal coupled to a first data line Vd1[m] for receiving the first data voltage.

The fifth transistor T5 has a gate coupled to the first signal line S1 [n] for responding to the first control signal, a first terminal coupled to a fourth node ndd at the other terminal of the second capacitor C2, and a second terminal coupled to a second data line Vd2[m] for receiving the second data voltage.

The sixth transistor T6 has a gate coupled to a second signal line S2[n] for responding to the second control signal, a first terminal coupled to the other terminal of the first capacitor C1 with respect to the third node ndc, and a second terminal coupled to the ramp voltage terminal Vramp[x] for receiving the ramp voltage.

The seventh transistor T7 has a gate coupled to a third signal line S3[n] in response to the third control signal, a first terminal coupled to the fourth node ndd, and a second terminal coupled to the reference voltage terminal for receiving the reference voltage Vref.

It should be understood that although the second transistor T2 and the fifth transistor T5 are both coupled to the first signal line S1 [n], and are respectively coupled to the first data line Vd1[m] and the second data line Vd2[m] as an example in this embodiment, in other embodiments of the present application, the second transistor T2 and the fifth transistor T5 may be coupled to different signal lines or coupled to the same data line. For example, in some embodiments of the present application, the gate of the second transistor T2 is coupled to a first branch signal line for responding to a first branch control signal of the first control signal, and a second terminal is coupled to a data line for receiving the first data voltage at a first timing. The fifth transistor T5 has a gate coupled to a second branch signal line for responding to a second branch control signal of the first control signal, and a second terminal coupled to the same data line for receiving the second data voltage at a second timing. Similarly, in some embodiments of the present application, the second transistor and the fifth transistor may be respectively coupled to different signal lines and different data lines, and perform corresponding operations in a timing control manner.

As shown in FIG. 2. The latch circuit 112 of the grayscale converter 110 includes a first transistor T1, a third transistor T3, and a set of back-to-back inverters. The first transistor T1 has a gate coupled to the first signal line S1[n] for responding to the first control signal, a first terminal coupled to the second node ndb, and a second terminal coupled to a first voltage end of the power driver for receiving the first voltage ELVDD. The third transistor T3 has a gate coupled to the third node for responding to the grayscale voltage, a first terminal coupled to the first node nda, and a second terminal coupled to the first voltage terminal for receiving the first voltage ELVDD.

The back-to-back inverters are coupled between the first node nda and the second node ndb and include a first inverter INV1 and a second inverter INV2 coupled with each other for maintaining the voltage levels of the first node nda and the second node ndb. A first output end of the first inverter INV1 is coupled to the second node ndb, and is coupled to a second input end of the second inverter INV2. Meanwhile, a second output end of the second inverter INV2 is coupled to the first node nda and coupled to a first input end of the first inverter INV1. Therefore, in this embodiment, when the first transistor T1 is turned on in response to the first control signal and transmits the first voltage ELVDD to the second node ndb, the first voltage ELVDD may be converted into a second voltage ELVSS, which is inverse with respect to the first voltage ELVDD, by the second inverter INV2 and transmitted to the first node nda to turn on the current generator 120. Similarly, when the third transistor T3 is turned on in response to the grayscale voltage and transmits the first voltage ELVDD to the first node nda, the first voltage ELVDD may be converted into a second voltage ELVSS, which is inverse with respect to the first voltage ELVDD, by the first inverter INV1 and transmitted to the second node ndb. In this process, the current generator 120 is turned off correspondingly due to the changing of the voltage of the first node nda.

The driving circuit 121 of the current generator 120 includes a fourth transistor T4. The fourth transistor T4 has a gate coupled to the first node nda for responding to a voltage level of the first node nda, a first terminal coupled to the switching circuit 122, and a second terminal coupled to a first power source (first voltage end) for receiving the first voltage ELVDD and a driving current. The switching circuit 122 includes an eighth transistor T8. The eighth transistor T8 has a gate coupled to the light signal line EM[n] for responding to a light signal, a first terminal coupled to the driving circuit 121, and a second terminal coupled to an anode of the electroluminescent element EL (e.g., micro LED, OLED, or AMOLED, etc.), and the cathode of the electroluminescent element EL is coupled to a second power supply (second voltage end) for receiving a second voltage ELVSS.

The pixel circuit of the embodiment of the present application is further described below in combination with some methods of driving the same.

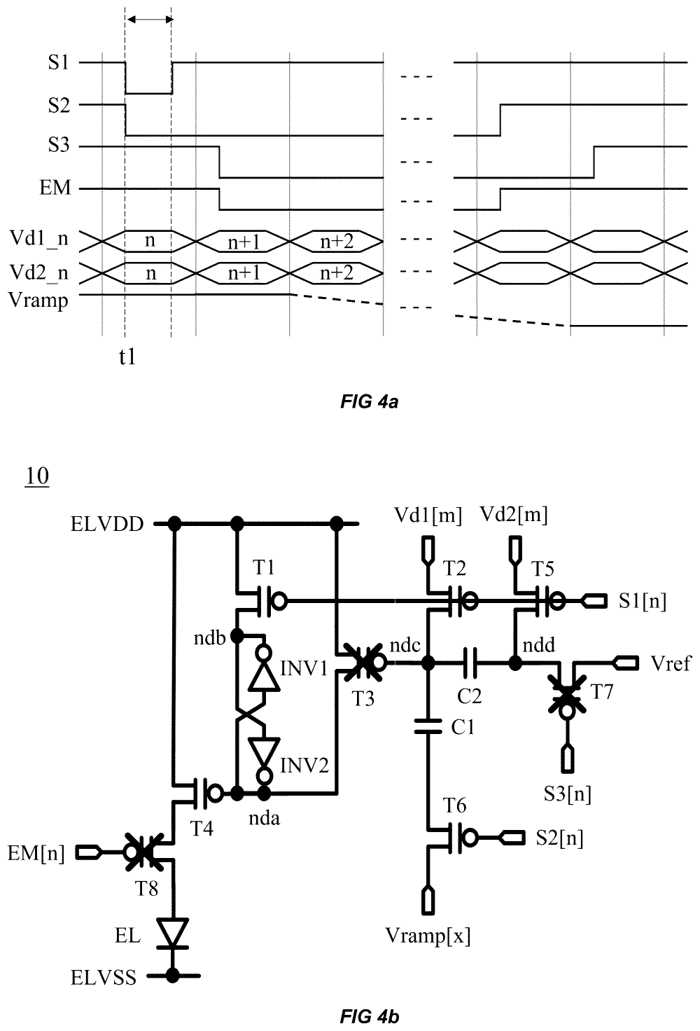

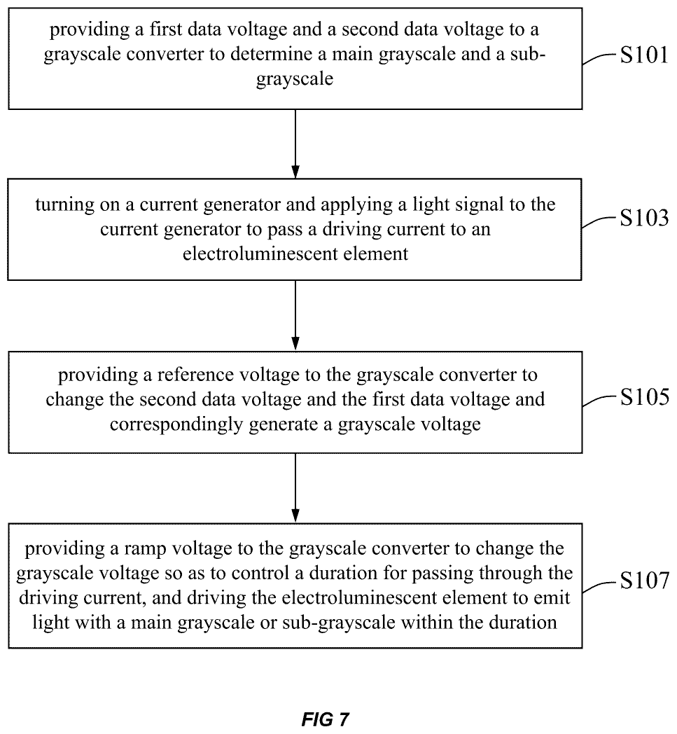

Reference now may be made to FIGS. 4a, 4b and 7. The method of driving the pixel circuit 10 according to an embodiment of the present application is applicable for controlling the grayscale of the EL element. First, a first data voltage and a second data voltage are provided to a grayscale converter to determine a main grayscale and a sub-grayscale (S101). In the first time period, a first control signal S1, a second control signal S2, a third control signal S3, and a light control signal EM are set to be negative-edge-triggered. At time t1, the first control signal S1 and the second control signal S2 are pulled to the falling edge, while the third control signal S3 and the light-emitting control signal EM at the high logic level are not pulled. At this time, a first transistor T1, a second transistor T2, and fourth to sixth transistors T4 to T6 are turned on, and a third transistor T3, a seventh transistor T7 and an eighth transistor T8 are turned off (marked with a “X” symbol in the drawing). Since the first transistor T1 is turned on, the voltage level of the second node ndb is applied as a first voltage ELVDD (Vb=ELVDD, corresponding to voltage level 1). And a first inverter INV1 and a second inverter INV2 cooperate to synchronously convert the first voltage ELVDD into the second voltage ELVSS so that the voltage level (referred as Va hereafter) of the first node nda is applied as the second voltage ELVSS (Va=ELVSS, corresponding to the voltage level 0). The fourth transistor T4 of the driving circuit 121 is turned on in response to the second voltage ELVSS to complete the initialization setting of the fourth transistor T4.

Meanwhile, since the second transistor T2 and the fifth transistor T5 are turned on, a voltage level of the third node ndc is applied as the first data voltage Vd1_n (Vc=Vd1_n); and a voltage level of the fourth node ndd is applied as the second data voltage Vd2_n (Vd=Vd2_n) to complete an addressing process of data voltage. At this time, the third transistor T3 is turned off in response to the first data voltage Vd1_n. The first data voltage Vd1_n is used as a main grayscale voltage for determining the main grayscale, and the second data voltage Vd2_n is used as a adjusting voltage of main grayscale for determining a sub-grayscale based on the main grayscales.

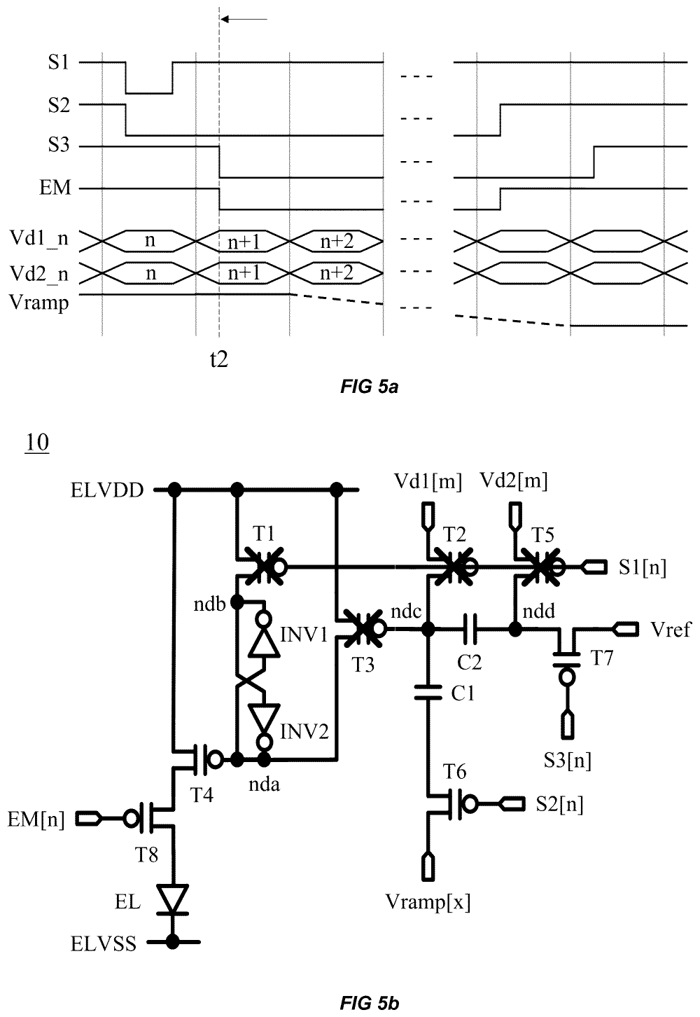

Reference now may be made to FIGS. 5a, 5b, and 7. Next, the current generator is turned on, and a light signal is applied to the current generator to pass a driving current to an electroluminescent element (S103). At time t2, the third control signal S3 and the light signal EM are pulled to the negative edge, while the first control signal S1 at the high voltage level and the second control signal S2 at the low voltage level are not pulled. At this time, the seventh transistor T7 and the eighth transistor T8 are turned on, and the fourth transistor T4 and the sixth transistor T6 are kept on. While the first to third transistors T1 to T3 and the fifth transistor T5 are turned off.

In this stage, the fourth transistor T4 is kept on in response to the second voltage ELVSS since Va and Vb are unchanged and remain the state of the previous phase (Va=ELVSS, Vb=ELVDD). Meanwhile, the eighth transistor T8 is turned on in response to the light signal EM, so that the driving current may be output to the electroluminescent element EL by turning on the fourth transistor T4 and the eighth transistor T8, causing the electroluminescent element EL to emit light. The driving current is determined by the low voltage of the light signal EM, and the equivalent output driving current may be expressed as the following equation.

$$\vert Id \vert = \frac{1}{2} \times μ \times {C}_{ox} \times {( ELVDD - {EM}_{L} - {\vert Vth \vert}_{T 8} )}^{2}$$

Id is a driving current flowing through the electroluminescent element EL; μ is mobility; Cox is a gate capacitor; EML is a low voltage of a light signal; and Vth is a threshold voltage of the eighth transistor T8.

Then, a reference voltage is provided to the grayscale converter to change the second data voltage and the first data voltage and correspondingly generate the grayscale voltage (S105). In this step, the seventh transistor T7 is turned on in response to the third control signal S3, and receives and transmits the reference voltage Vref to the fourth node ndd, so that Vd is changed to the reference voltage Vref (Vd=Vref), while Vc is changed correspondingly by the second capacitor C2, and the grayscale voltage (i.e., changed Vc) is generated at the third node ndc. At this time, the voltage level Vc of the third node ndc may be expressed as the following equation.

Vc=Vd1_n+[C2/(C1+C2)]*(Vref−Vd2_n)

Since the second data voltage Vd2_n affects the multiplier of Vc and is a divided voltage of the capacitor connected in series, and thus the third transistor T3 may be provided with a finer bias variation in comparison with the first data voltage Vd1_n, thereby achieving the setting of the grayscale voltage.

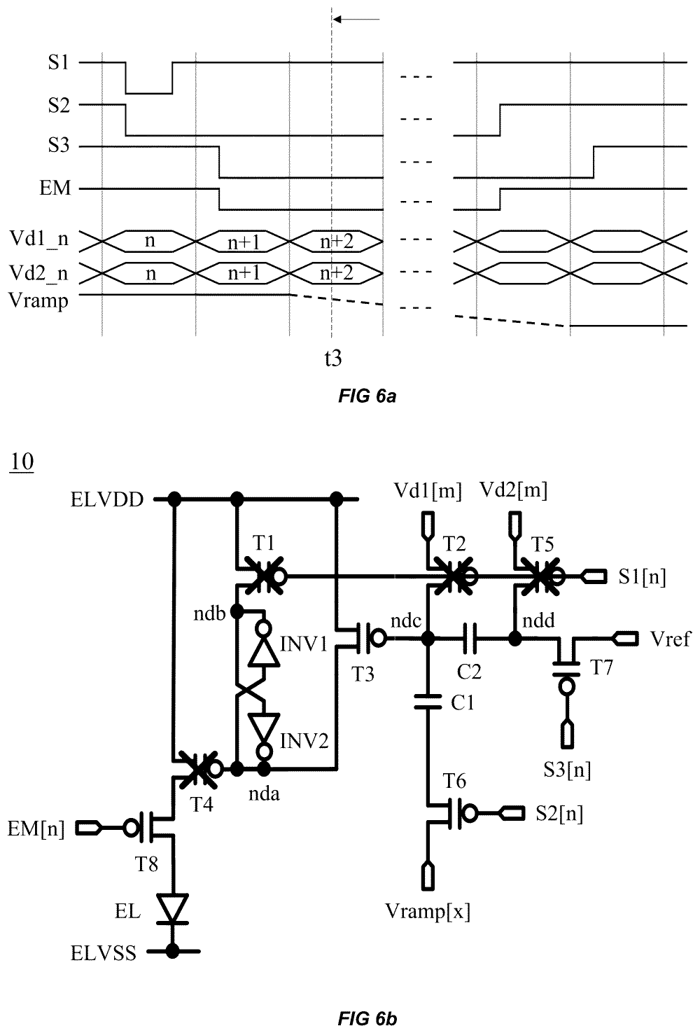

Reference now may be made to FIGS. 6a, 6b and 7. Then, a ramp voltage is provided to the grayscale converter to change the grayscale voltage, so as to control the passing time of the driving current, and drive the electroluminescent element to emit light with the main grayscale or the sub-grayscale of the passing time (S107). At the time point t3, the first control signal S1, the second control signal S2, the third control signal S3, and the light signal EM are not pulled. At this time, the sixth transistor T6 is kept on in response to the second control signal S2, such that the ramp voltage Vramp is transmitted to the first capacitor C1. Meanwhile, as the waveform of the ramp voltage Vramp changes, Vc is changed by the first capacitor C1, so that the grayscale voltage decreases due to the changing of waveform of the ramp voltage Vramp, which may be expressed as an equation: Vc<ELVDD−|VthT3|.

As the grayscale voltage decreases, after a predetermined time, the third transistor T3 is turned on in response to the changed grayscale voltage, such that the voltage level Va of the first node nda is applied as the first voltage ELVDD (Va=ELVDD, corresponding to the voltage level 1). Moreover, the first voltage ELVDD is synchronously converted into the second voltage ELVSS by the cooperation of the first inverter INV1 and the second inverter INV2, and the voltage level Vb of the second node ndb is applied as the second voltage ELVSS (Vb=ELVSS, corresponding to the voltage level 0). At this time, the fourth transistor T4 of the driving circuit 121 is turned off in response to the first voltage ELVDD to cut off the passing of driving current to the electroluminescent element EL, so that the electroluminescent element EL stops emitting light. An equivalent equation of cutting off driving current may be represented by the following equation:

$$\vert Id \vert = \frac{1}{2} \times μ \times {C}_{ox} \times {( ELVDD - {EM}_{L} - {\vert Vth \vert}_{T 3} )}^{2} \sim 0 ; \\ \vert VgsT 3 \vert > \vert VthT 3 \vert$$

Therefore, in the embodiment of the present application, the grayscale voltage may be set by establishing the first data voltage and the second data voltage, and the first data voltage is used as the main grayscale voltage, and the second data voltage is used as the adjustment voltage of the main grayscale voltage, so that the grayscale voltages may be the main grayscale voltages or the sub-grayscale voltages formed after adjustment. Meanwhile, with the applying of ramp voltage, the duration for passing through the driving current corresponding to each main grayscale and each sub-grayscale are different, so that the electroluminescent element may emit light with a corresponding main grayscale or emit light with one of a plurality of sub-grayscales between a previous grayscale and a next grayscale of the main grayscale on the basis of the main grayscales, Thereby the electroluminescent element may be adjusted in a small data range to obtain a finer picture closer to the real grayscale.

It can be understood that although in the pixel circuit of the above embodiment, the transistor is exemplified as a p-type TFT or PMOS transistor, in other embodiments of the present disclosure, the pixel circuit maybe implemented with an equivalent circuit in which the fourth transistor may be a p-type TFT or PMOS transistor, and other transistor are n-type TFT or NMOS transistors correspondingly. Therefore, in this type of pixel circuit, the grayscale voltage is pulled by the ramp voltage and increases within the duration, so as to turn off the current generator.

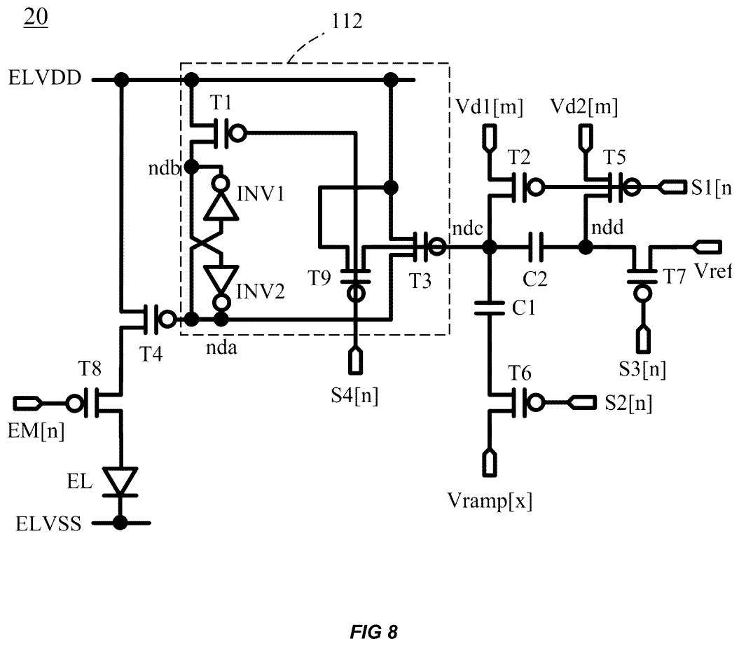

Reference now may be made to FIG. 8. The pixel circuit 20 according to another embodiment of the present application is similar to the pixel circuit 10 shown in FIG. 2, except that the latch circuit 112 further includes a ninth transistor T9. The ninth transistor T9 has a gate coupled to a fourth signal terminal S4[n] for responding to a fourth control signal, a first terminal coupled to the third node ndc, and a second terminal coupled to the first voltage end. The gate of the first transistor T1 of the latch circuit 112 is also coupled to the fourth signal terminal S4[n]. Therefore, in the method for driving the pixel circuit 20 of the present embodiment, a fourth control signal may be applied to the latch circuit 112 before or simultaneously with the step of applying the first control signal, such that the first transistor T1 is turned on in response to the fourth control signal and passes the first voltage ELVDD to the second node ndb; and the ninth transistor T9 is turned on in response to the fourth control signal to transmit the first voltage ELVDD to the third node ndc.

At this time, the third transistor T3 is turned off in response to the voltage level (i.e., the first voltage ELVDD) of the third node ndc, and the voltage level of the first node nda is maintained at the second voltage ELVSS with the cooperation of the first inverter INV1 and the second inverter INV2, such that the fourth transistor T4 of the driving circuit 121 is turned on. Therefore, in the present embodiment, the configuration of the ninth transistor T9 ensures that an initialized setting that the fourth transistor T4 of the driving circuit 121 is turned on, which improves the reliability and stability of the operation of the pixel circuit 20.

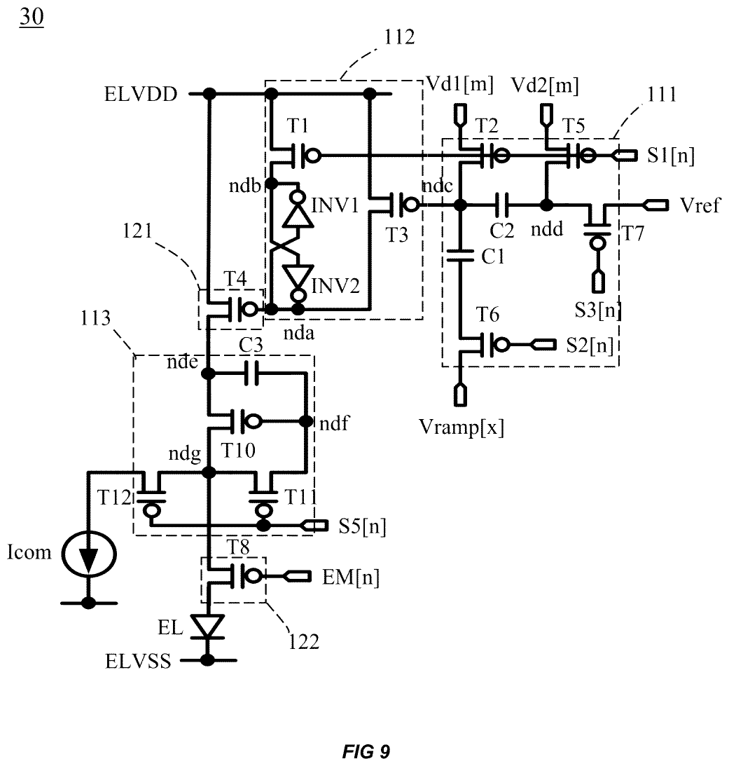

Reference now may be made to FIG. 9. The pixel circuit 30 provided in some embodiments of the present application is similar to the pixel circuit 10 shown in FIG. 2, except that the grayscale converter 110 further includes a compensation circuit 113 coupled between a fifth node nde and a seventh node ndg. The driving circuit 121 of the current generator 120 is coupled to the fifth node nde, the switching circuit 122 is coupled to the seventh node ndg. The compensation circuit 113 is configured to establish a compensation voltage at a sixth node ndf in response to a fifth control signal, and transmit a compensation current Icom to the switching circuit 122 according to the compensation voltage.

In some embodiments of the present application, the compensation circuit 113 includes a third capacitor C3, a tenth transistor T10, an eleventh transistor T11, and a twelfth transistor T12. The third capacitor C3 is coupled between the fifth node nde and the sixth node ndf for maintaining a voltage difference between the fifth node nde and the sixth node ndf. The tenth transistor has a gate coupled to the sixth node ndf in response to the compensation voltage, a first terminal coupled to the seventh node, and a second terminal coupled to the fifth node. The eleventh transistor T11 has a gate coupled to a fifth signal terminal S5[n] in response to the fifth control signal, a first terminal coupled to the sixth node ndf, and a second terminal coupled to the seventh node ndg. The twelfth transistor T12 has a gate coupled to a fifth signal end in response to the fifth control signal, a first terminal coupled to the seventh node ndg, and a second terminal coupled to an external fixed current source for receiving the compensation current Icom.

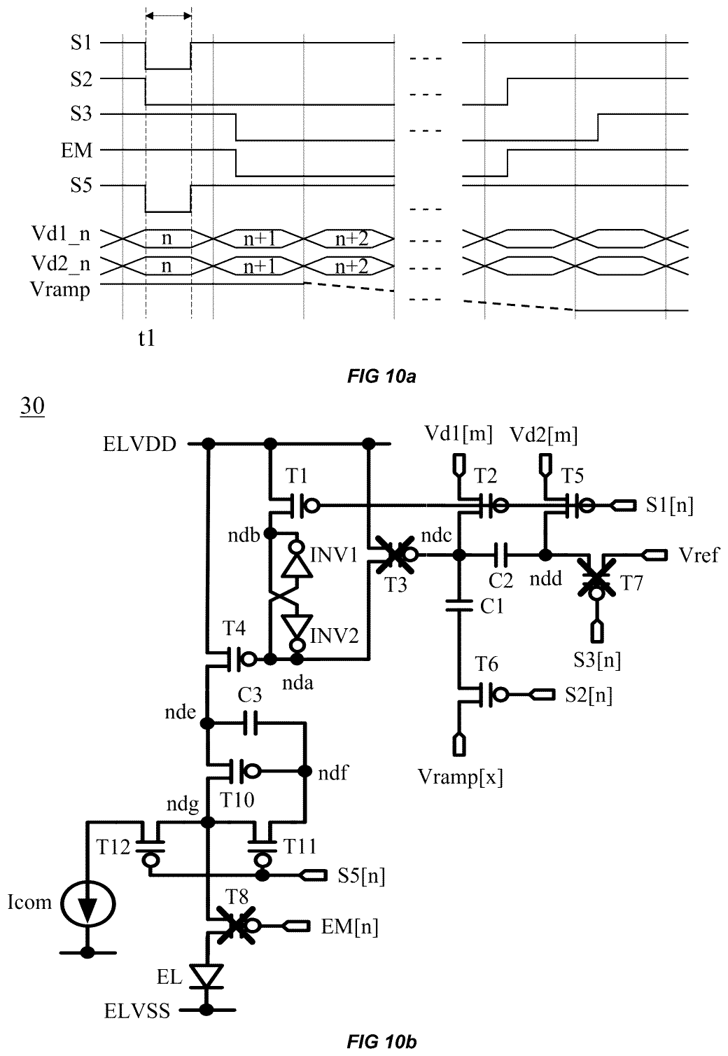

As shown in FIG. 10a and FIG. 10B, the basis structure of pixel circuit 30 of the present embodiment is substantially same as that of the pixel circuit 10 shown in FIG. 2 and thus the method of driving the pixel circuit 30 is almost same as the method described above, except that in the method of driving the pixel circuit 30 of the present embodiment, the fifth control signal S5 is pulled to a negative edge at time t1, so that the eleventh transistor T11 and the twelfth transistor T12 are respectively turned on in response to the fifth control signal S5 to pass the compensation current Icom. At the same time, the eleventh transistor T11 and the twelfth transistor T12 transmit the compensation voltage to the sixth node ndf to determine the voltage level (referred as Vf hereafter) of the sixth node ndf, thereby completing the threshold voltage compensation operation. The equational relationship of passing the compensation current may be expressed as the following equation:

$$\vert Id \vert = \frac{1}{2} \times μ \times {C}_{ox} \times {( ELVDD - Ve )}^{2} = Icom$$

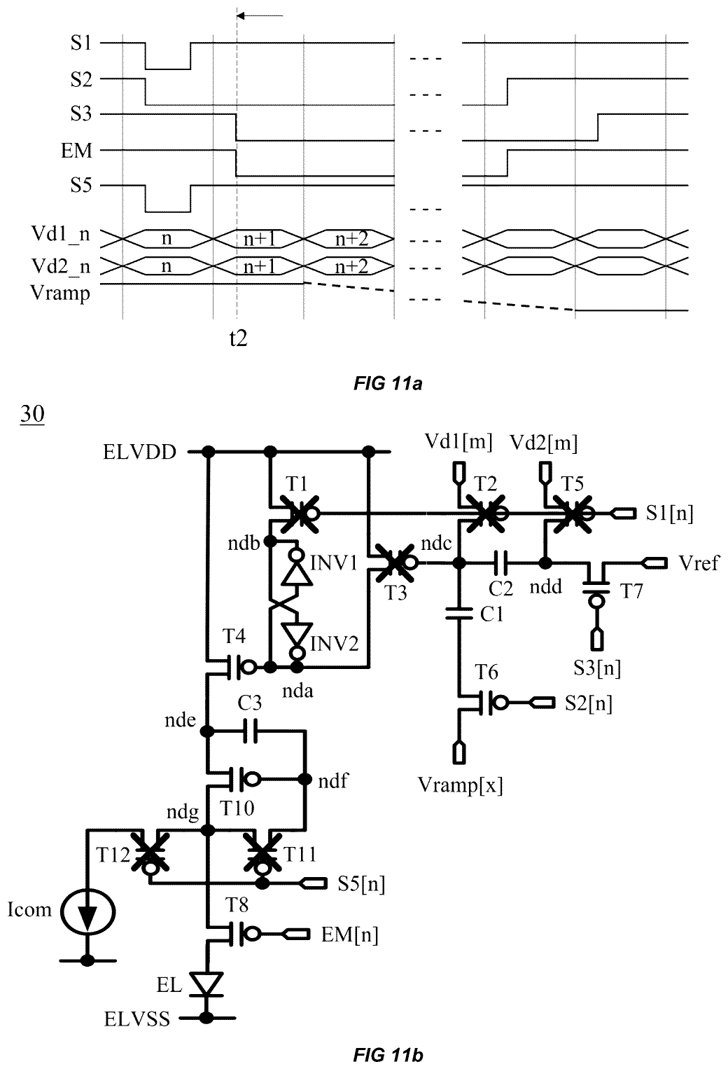

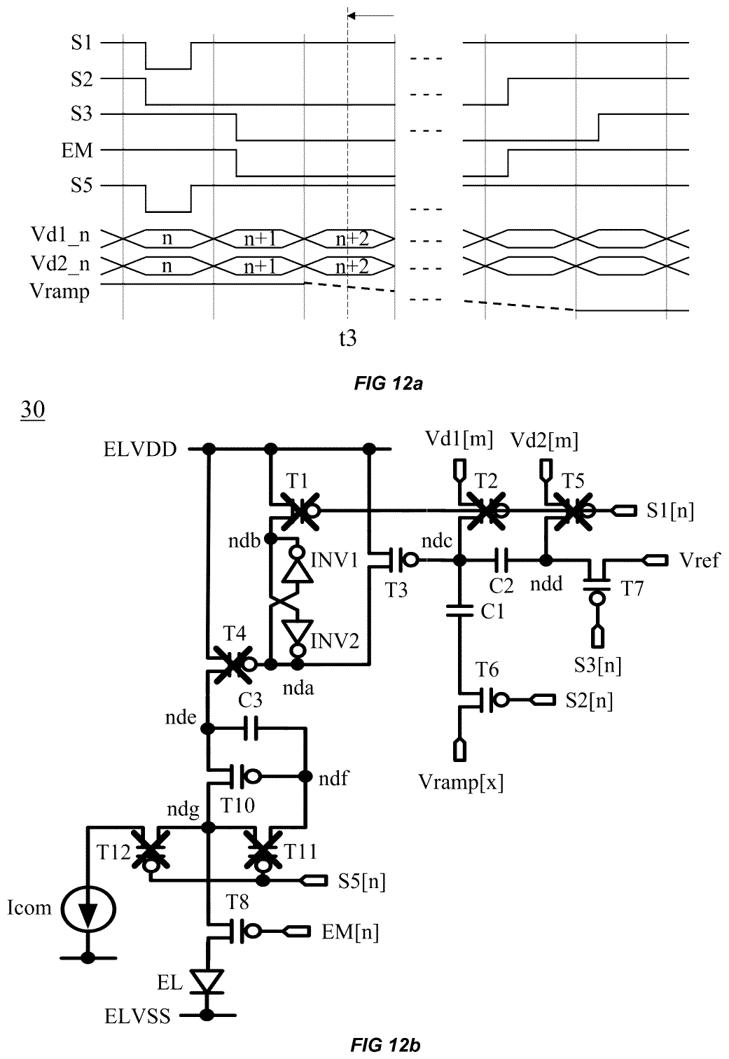

Reference now may be made to FIGS. 11a and 11b. Next, at a time point t2, a bias value of the gate-source voltage (|VgsT10|) of the tenth transistor T10 is held by the third capacitor C3, so that the tenth transistor T10 transmits the compensation current Icom as a driving current to the switching circuit 122. Meanwhile, the eighth transistor T8 is turned on in response to the light signal EM, thereby the compensation current Icom is transmitted to the electroluminescent element EL to drive the electroluminescent element EL to emit light. Then, as shown in FIGS. 12a and 12b, at a time point t3, with the ramp voltage Vramp, the third transistor T3 of the latch circuit 112 is turned on, and the fourth transistor T4 of the driving circuit 121 is correspondingly turned off, so that the compensation current Icom of the tenth transistor T10 stops outputting, and the electroluminescent element EL stops emitting light.

Characteristics of various embodiments summarized above are for better understanding of one skilled in the art on the present disclosure. One skilled in the art should understand that the present disclosure is convenient to be used as a basis of designing or modifying other processes and structures to implement the embodiments described in the present disclosure for same objects and/or achieve same advantages. One skilled in the art should also understand that such equivalent constructions are within the spirit and scope of the present disclosure, and various variations, modifications, alternatives can be made thereto without departing from the spirit and scope of the present disclosure.

1. A pixel circuit comprising:
a current generator configured to pass through a driving current to an electroluminescent element; and
a grayscale converter configured to receive a first data voltage, a second data voltage, a reference voltage, and a ramp voltage, and change the second data voltage and the first data voltage according to the reference voltage to generate a grayscale voltage correspondingly; and change the grayscale voltage according to the ramp voltage to control a duration of the driving current passes through the current generator, and drive the electroluminescent element to emit light with a grayscale corresponding to the duration;
wherein the grayscale comprises a main grayscale corresponding to the first data voltage and a sub-grayscale corresponding to the second data voltage, and the sub-grayscale is one of a plurality of sub-grayscales between the main grayscale and a previous grayscale of the main grayscale and between the main grayscale and a next grayscale of the main grayscale.

2. The pixel circuit according to claim 1, wherein the grayscale converter comprises:
a converting circuit configured to receive the first data voltage and the second data voltage in response to a first control signal, receive the reference voltage in response to a third control signal, and receive the ramp voltage in response to the second control signal, the grayscale voltage increases or decreases progressively within the duration by being pulled by the ramp voltage; and
a latch circuit coupled to the current generator, and configured to receive a first voltage and establish the first voltage at a second node to turn on the current generator, and configured to establish the first voltage at a first node to turn off the current generator within the duration.

3. The pixel circuit according to claim 2, wherein the converting circuit comprises a first capacitor and a second capacitor connected in series, wherein
the second capacitor is coupled between a third node and a fourth node, the first data voltage is established at the third node, the second data voltage is established at the fourth node, and the second capacitor changes the second data voltage and the first data voltage according to the reference voltage to generate the grayscale voltage at the third node;
the first capacitor is coupled to the third node and a ramp voltage end and configured to change the gray scale voltage according to the ramp voltage.

4. The pixel circuit according to claim 3, wherein the converting circuit further comprises:
a second transistor respectively coupled to a data line and the third node, and configured to transmit the first data voltage to the third node in response to the first control signal;
a fifth transistor respectively coupled to the data line and the fourth node, and configured to transmit the second data voltage to the fourth node in response to the first control signal;
a sixth transistor respectively coupled to the first capacitor and the ramp voltage end, and configured to transmit the ramp voltage to the first capacitor in response to the second control signal; and
a seventh transistor respectively coupled to the fourth node and a reference voltage end, and configured to transmit the reference voltage to the fourth node in response to the third control signal.

5. The pixel circuit according to claim 4, wherein the data line comprises a first data line and a second data line, the second transistor is coupled between the first data line and the third node, and the fifth transistor is coupled between the second data line and the fourth node.

6. The pixel circuit according to claim 5, wherein a gate of the second transistor is coupled to a first branch signal line and configured to transmit the first data voltage to the third node in response to a first branch control signal of the first control signal, a gate of the fifth transistor is coupled to a second branch signal line, and configured to transmit the second data voltage to the fourth node in response to a second branch control signal of the first control signal.

7. The pixel circuit according to claim 5, wherein the latch circuit comprises:
a first transistor respectively coupled to a first voltage end and the second node, and configured to transmit the first voltage to the second node in response to the first control signal;
a third transistor respectively coupled to the first node, the third node, and the first voltage end, and configured to transmit the first voltage to the first node in response to the grayscale voltage;
a set of back-to-back inverters coupled between the first node and the second node, and configured to maintain the first voltage at the first node and simultaneously establish a second voltage opposite to the first voltage at the second node, or maintain the second voltage at the second node and simultaneously establish the first voltages at the first node.

8. The pixel circuit according to claim 7, wherein the back-to-back inverters comprise:
a first inverter and a second inverter, a first output of the first inverter being coupled to the second node and to a second input of the second inverter, and a second output of the second inverter being coupled to the first node and to a first input of the first inverter.

9. The pixel circuit according to claim 5, wherein the latch circuit comprises:
a first transistor respectively coupled to a first voltage end and the second node, and configured to transmit the first voltage to the second node in response to a fourth control signal;
a third transistor respectively coupled to the first voltage end, the first node, and the third node, and configured to transmit the first voltage to the first node in response to the grayscale voltage;
a ninth transistor respectively coupled to the first voltage end and the third node, and configured to transmit the first voltage to the third node in response to the fourth control signal to turn off the third transistor; and
a set of back-to-back inverters, coupled between the first node and the second node, and configured to maintain the first voltage at the first node and simultaneously establish a second voltage opposite to the first voltage at the second node, or maintain the second voltage at the second node and simultaneously establish the first voltages at the first node.

10. The pixel circuit according to claim 3, wherein the current generator comprises:
a driving circuit coupled to the first node, and configured to receive the first voltage and transmit the driving current to a switching circuit, and be turned on or off according to a voltage level of the first node; and
a switching circuit coupled between the driving circuit and the electroluminescent element, and configured to receive and transmit the driving current to the electroluminescent element in response to a light signal.

11. The pixel circuit according to claim 10, wherein the driving circuit comprises a fourth transistor, a gate of the fourth transistor being coupled to the first node and configured to be turned off in response to the first voltage; the switching circuit comprises an eighth transistor, wherein a gate of the eighth transistor is coupled to a light signal end and is configured to pass the driving current in response to the light signal.

12. The pixel circuit according to claim 10, further comprising a compensation circuit, wherein the driving circuit is coupled to the fifth node, the switching circuit is coupled to the seventh node, and the compensation circuit is coupled between a fifth node and a seventh node and configured to establish a compensation voltage at a sixth node in response to a fifth control signal, and transmit a compensation current to that switching circuit according to the compensation voltage.

13. The pixel circuit according to claim 12, wherein the compensation circuit comprises:
a third capacitor coupled between the fifth node and the sixth node, and configured to maintain a voltage difference between the fifth node and the sixth node;
an eleventh transistor coupled between the sixth node and the seventh node, and configured to transmit a compensation voltage to the sixth node in response to a fifth control signal;
a twelfth transistor respectively coupled to the seventh node and a compensation current end, and configured to pass the compensation current in response to the fifth control signal; and
a tenth transistor coupled to the fifth node, the sixth node, and the seventh node respectively, and configured to transmit the compensation current to the switching circuit in response to the compensation voltage.

14. An electroluminescence display comprising:
an array of pixel cells, wherein each pixel cell comprises the pixel circuit according to claim 1 and an electroluminescent element coupled to the pixel circuit.

15. A driving method for driving a pixel circuit, comprising:
providing a first data voltage and a second data voltage to a grayscale converter to determine a main grayscale and a sub-grayscale, wherein the sub-grayscale is one of a plurality of sub-grayscales between the main grayscale and a previous grayscale of the main grayscale and between the main grayscale and a next grayscale of the main grayscale;
turning on a current generator and applying a light signal to the current generator to pass a driving current to an electroluminescent element;
providing a reference voltage to the grayscale converter to change the second data voltage and the first data voltage and correspondingly generate a grayscale voltage, and
providing a ramp voltage to the grayscale converter to change the grayscale voltage so as to control a duration for passing the driving current, and drive the electroluminescent element to emit light with the main grayscale or the sub-grayscale corresponding to the duration.

16. The driving method according to claim 15, further comprising:
establishing a second voltage at the grayscale converter to turn on the current generator, and
changing the second voltage into a first voltage when the duration is over, so as to turn off the current generator and cut off the driving current.

17. The driving method according to claim 16, further comprising:
applying a first control signal to a converting circuit of the grayscale converter to establish the first data voltage at a third node and the second data voltage at a fourth node;
receiving the first voltage by a latch circuit of the grayscale converter, and establishing the first voltage at a second node, and correspondingly generating the second voltage at a first node;
turning on a driving circuit of the current generator in response to the second voltage and transmitting the driving current to the switching circuit;
passing the driving current by the switching circuit in response to the light signal, and driving the electroluminescent element to emit light;
applying a third control signal to the converting circuit to receive the reference voltage to the fourth node to change the second data voltage, and correspondingly change the first data voltage by a second capacitor to generate the grayscale voltage at the third node;
applying a second control signal to the converting circuit to receive the ramp voltage and pull the grayscale voltage to be increased or decreased within a duration corresponding to the main grayscale or the sub-grayscale by a first capacitor, and
transmitting, by the latch circuit, the first voltage to the first node in response to a changed grayscale voltage when the duration is over, to turn off the driving circuit.

18. The driving method according to claim 17, further comprising:
turning on a first transistor of the latch circuit to receive and transmit the first voltage to the second node;
converting the first voltage to the second voltage by a set of back-to-back inverters between the second node and the first node, and transmitting the second voltage to the first node; and
turning off the first transistor and turning on the third transistor of the latch circuit when the duration is over, to receive and transmit the first voltage to the first node, and simultaneously convert the first voltage into the second voltage by the back-to-back inverters and transmit the second voltage to the second node.

19. The driving method according to claim 18, further comprising:
applying a fourth control signal to the first transistor to turn on the first transistor, and
applying the fourth control signal to a ninth transistor of the latch circuit to pass the first voltage to the third node such that the third transistor is turned off in response to the first voltage.

20. The driving method according to claim 17, wherein the step of applying a light signal to the current generator to pass a driving current to an electroluminescent element further comprises:
applying a fifth control signal to a compensation circuit to establish a compensation voltage and turn on the compensation circuit;
converting the driving current into a compensation current according to the compensation voltage; and
applying the light signal to the current generator to pass the compensation current to the electroluminescent element.
